(19) United States
(12) Patent Application Publication
(10) Pub. No.: US 2024/0386236 A1
(43) Pub. Date: Nov. 21, 2024

(54) FLOW FIELD IDENTIFICATION METHOD OF ARTIFICIAL INTELLIGENCE FISH SIMULATION SYSTEM

(71) Applicants: Chongqing Jiaotong University, Chongqing (CN); Chongqing Xike Consulting Co., LTD for Water Transport Engineering, Chongqing (CN)

(72) Inventors: Chunze ZHANG, Chongqing (CN); Tao LI, Chongqing (CN); Ji HOU, Chongqing (CN); Qin ZHOU, Chongqing (CN); Qian MA, Chongqing (CN); Peiyi PENG, Chongqing (CN); Jiashan MI, Chongqing (CN); Lingyun XIE, Chongqing (CN); Wei DIAO, Chongqing (CN); Zhan ZHANG, Chongqing (CN)

(73) Assignees: Chongqing Jiaotong University, Chongqing (CN); Chongqing Xike Consulting Co., LTD for Water Transport Engineering, Chongqing (CN)

(21) Appl. No.: 18/226,783

(22) Filed: Jul. 27, 2023

(30) Foreign Application Priority Data
May 15, 2023 (CN) 202310545999.7

(51) Int. Cl. G06N 3/006; G06N 3/084

(52) U.S. Cl. CPC G06N 3/006; G06N 3/084

(57) ABSTRACT

A flow field identification method of artificial intelligence fish simulation system uses cluster server parallel sampling to obtain continuous flow field time series information data. After preprocessing the data, the method uses the lateral line perceptron of recurrent neural network or convolutional neural network based on long time series to continuously acquire data, train and iterate. Finally, the method can identify the flow field sequence data signal with time series property, wherein, the perceived flow field signals include but are not limited to velocity, pressure and vorticity, and the experimental results are continuously filled into the experimental database, which will have the effect of memory transplantation on the artificial fish and reduce the occurrence of repetitive errors. The method identifies the flow field of an artificial intelligence fish simulation system, which can fully reflect the characteristics of the flow field from the aspects of amplitude, frequency, and wavelength.

### CROSS-REFERENCE OF THE RELATED APPLICATION

This application is based upon and claims priority to Chinese Patent Application No. 202310545999.7 filed on May 15, 2023, the entire content of which is incorporated herein by reference.

### TECHNICAL FIELD

The present invention relates to the field of artificial fish flow field identification technology, and particularly relates to a flow field identification method of artificial intelligence fish simulation system.

### BACKGROUND

Water conservancy ecological environment protection is a very important proposition in recent years, With the continuous progress of entity equipment, mathematical model, computer technology and network communication technology, its solving space has shown a trend of extending from traditional physical solution to digital solution. To realize the bidirectional mapping and dynamic interaction between the virtual and the real in the physical/digital world in the field of aquatic ecology, it is necessary to solve a key problem—digitalization aquatic organisms with autonomous behavior and decision-making ability. Therefore, people have developed artificial bionic side line machine. The sideline function is of great significance to the survival and adaptation of fish in nature. Fish can perceive the water flow in the environment through the sideline function, thus reducing the difference between virtual intelligent fish and real fish in nature to a certain extent. At present, the proposed bionic lateral flow field perceptron is mainly based on the construction of primary deep neural network and can only deal with discrete, discontinuous flow field signal data. However, in nature, the signals received by fish are usually continuous one-dimensional time series signals. Therefore, the existing methods still have defects and cannot completely narrow the gap between virtual intelligent fish and real fish. Compared with the fish-like lateral flow field perceptron which processes discontinuous and discrete signals, the flow field data signals in real world usually have the characteristics of high drift, high noise and high nonlinearity. These characteristics are difficult to describe by discrete signals. In addition, the intelligent fish coupled with the primary sideline function cannot adapt to the unsteady flow with variable flow velocity. So this is very different from the behavior pattern of real fish in nature. Therefore, a flow field identification method of artificial intelligence fish simulation system is provided.

### SUMMARY

The purpose of the invention is to provide a flow field identification method of artificial intelligence fish simulation system. It uses cluster server parallel sampling. It also uses the perceptron of recurrent neural network or convolutional neural network based on long time series to continuously acquire data, train and iterate to identify the flow field sequence data signals with time series properties, the perceived flow field signals include but are not limited to flow velocity, pressure and vorticity.

To achieve the above purposes, the present invention provides a flow field identification method of artificial intelligence fish simulation system, including the following steps:
S1. deploying multiple simulation environments and deploying smart fish after deep reinforcement learning training in the simulation environment, composing simulation test database, simulation testing and parallel sampling of multiple simulation environments, collecting continuous flow field time series information data, and marking the collected continuous flow field time series information data accordingly;
S2. performing data preprocessing on the collected flow field time series information data, and storing the preprocessed continuous flow field time series information data in the flow field memory database;
S3. using the continuous flow field time series information data in the flow field memory database, adopting supervised learning method, training the lateral line perceptron based on neural network, and testing the recognition ability of the lateral line perceptron after training, when the lateral line perceptron does not meet the requirements, returning to step S1, continuing to collect data and training; when the lateral line perceptron meets the requirements, entering the next step;
S4. the lateral line perceptron that meets the requirements of use is coupled with the artificial intelligence fish simulation system, simulation testing in flow field. The lateral line perceptron continuously judges and identifies the current flow field to obtain identification result. The artificial intelligence fish simulation system adopts the corresponding swimming strategy according to the identification results;
S5. entering the simulation test in S4 into the simulation test database in step S1.

Preferably, in step S2, the data preprocessing methods include data standardization and segmentation. Data standardization converts the signal into zero mean and unit variance, and segmentation divides the signal into blocks of fixed length.

Preferably, in the step S3, the lateral line perceptron is set as an advanced neural network built by convolutional neural network or a recurrent neural network based on long short-term memory.

Preferably, in the training method of step S3, in the training of the lateral line perceptron, updating the network weight and bias using back propagation algorithm, using adaptive moment estimation momentum optimizer to adjust relevant parameters.

Preferably, there are two methods to test the lateral line perceptron in step S3, the first is to reduce the loss value calculated by the cross entropy loss function trained by the training data set to a pre-set standard value, and it is stable in a long time, indicating that the network optimization is completed; the second is to use the trained perceptron to perform pre-perception on the judgment data set, the number of pre-perception failures is less than the set expected number of failures, indicating that the network optimization is completed.

Preferably, in the step S4, the identification method is to send the current observed flow field sequence data signal of the artificial intelligence fish as the input signal to the trained lateral line perceptron, and quickly output the identification result according to the mark established in step S1.

Therefore, the present uses the above flow field identification method of artificial intelligence fish simulation system, having the following beneficial effects:

(1) In the present invention, a cluster server is used to build multiple simulation environments for parallel data acquisition, and the data acquisition is faster.

(2) In this present invention, the continuous time series waveform signal is used as the input of the lateral line perceptron. Compared with the discontinuous and discrete signals, the continuous flow field time series signal will be able to reflect the characteristics of the flow field more comprehensively.

(3) In the present invention, using continuous time series information data in the flow field memory database to train a lateral line perceptron based on a convolutional neural network or a recurrent neural network, using convolutional neural network (CNN) can effectively capture the spatiotemporal locality of the signal, using recurrent neural network (RNN) is more suitable for processing time series data. The network structure will be selected according to the form of the flow field observation signal, so that the identification of the flow field is more targeted and better detected.

(4) In the present invention, the collected data are preprocessed by data mean and segmentation preprocessing, wherein data mean is helpful to improve the training effect, and segmentation is helpful to the processing of neural network.

(5) In this present invention, the process of simulation test can input it into the step S1 simulation test database. Through continuous result feedback, the generated intelligent fish will have the memory of the early generated intelligent fish, reducing the possibility of repeated errors.

The following is a further detailed description of the technical scheme of the invention through drawings and implementation examples.

### BRIEF DESCRIPTION OF THE DRAWINGS

FIG. 1 is a flow chart of the flow field identification method of artificial intelligence fish simulation system of the present invention;

FIG. 2 is the flow field velocity diagram of the fish movement when the time is 7T in example 1 of the flow field identification method of artificial intelligence fish simulation system;

FIG. 3 is the flow field velocity diagram of the fish movement when the time is 17T in example 1 of the flow field identification method of artificial intelligence fish simulation system;

FIG. 4 is the flow field velocity diagram of the fish movement when the time is 27T in example 1 of the flow field identification method of artificial intelligence fish simulation system;

FIG. 5 is the flow field velocity diagram of the fish movement when the time is 29T in example 1 of the flow field identification method of artificial intelligence fish simulation system;

FIG. 6 is the vorticity cloud atlas of fish movement when the time is 7T in example 1 of the flow field identification method of artificial intelligence fish simulation system;

FIG. 7 is the vorticity cloud atlas of fish movement when the time is 17T in example 1 of the flow field identification method of artificial intelligence fish simulation system;

FIG. 8 is the vorticity cloud atlas of fish movement when the time is 27T in example 1 of the flow field identification method of artificial intelligence fish simulation system;

FIG. 9 is the vorticity cloud atlas of fish movement when the time is 29T in example 1 of the flow field identification method of artificial intelligence fish simulation system;

FIG. 10 is the schematic diagram of artificial intelligence fishtail beat frequency diagram in the case of unsteady flow in example 1 of the flow field identification method of artificial intelligence fish simulation system;

FIG. 11 is the artificial fish trajectory and other schemes of artificial fish trajectory comparison diagram in example 1 of the flow field identification method of artificial intelligence fish simulation system;

FIG. 12 is the flow field velocity diagram of the fish movement when the time is 7T in example 2 of the flow field identification method of artificial intelligence fish simulation system;

FIG. 13 is the flow field velocity diagram of the fish movement when the time is 17T in example 2 of the flow field identification method of artificial intelligence fish simulation system;

FIG. 14 is the flow field velocity diagram of the fish movement when the time is 27T in example 2 of the flow field identification method of artificial intelligence fish simulation system;

FIG. 15 is the flow field velocity diagram of the fish movement when the time is 29T in example 2 of the flow field identification method of artificial intelligence fish simulation system;

FIG. 16 is the vorticity cloud atlas of fish movement when the time is 7T in example 1 of the flow field identification method of artificial intelligence fish simulation system;

FIG. 17 is the vorticity cloud atlas of fish movement when the time is 17T in example 1 of the flow field identification method of artificial intelligence fish simulation system;

FIG. 18 is the vorticity cloud atlas of fish movement when the time is 27T in example 1 of the flow field identification method of artificial intelligence fish simulation system;

FIG. 19 is the vorticity cloud atlas of fish movement when the time is 29T in example 1 of the flow field identification method of artificial intelligence fish simulation system;

FIG. 20 is the schematic diagram of artificial intelligence fishtail beat frequency diagram in the case of unsteady flow in example 2 of the flow field identification method of artificial intelligence fish simulation system;

FIG. 21 is the artificial fish trajectory and other schemes of artificial fish trajectory comparison diagram in example 2 of the flow field identification method of artificial intelligence fish simulation system;

### DETAILED DESCRIPTION OF THE EMBODIMENTS

In order to make the purpose, technical scheme and advantages of the example of the present invention more clear, the following will describe the technical scheme of the example of the present invention clearly and completely in combination with the drawings of the example of the present invention. Therefore, the following detailed description of the embodiment of the present invention provided in the drawings is not intended to limit the scope of the present invention requiring protection, but only to indicate the selected embodiment of the invention. Based on the examples in this present invention, all other examples obtained by ordinary technicians in this field without making creative labor belong to the scope of protection of this present invention.

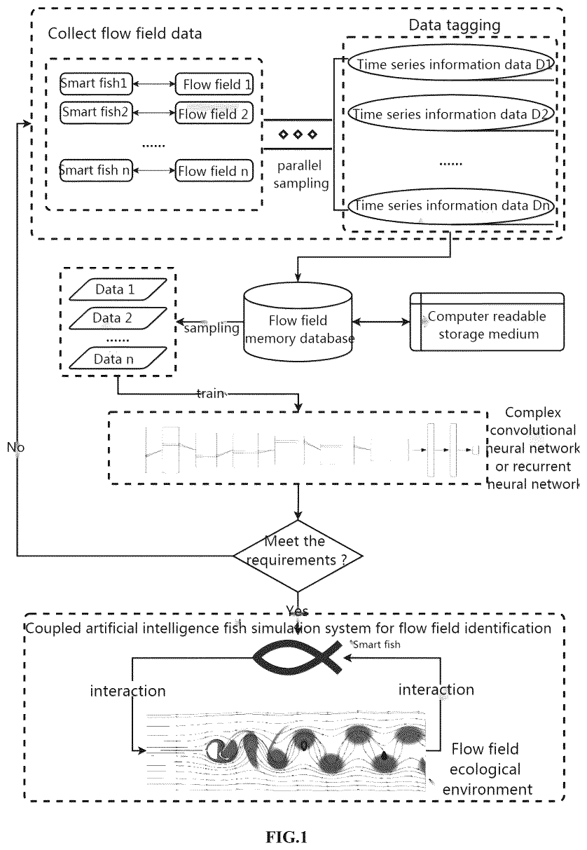

As shown in FIG. 1, the present invention provides a flow field identification method of artificial intelligence fish simulation system, including the following steps:

To achieve the above purposes, the present invention provides a flow field identification method of artificial intelligence fish simulation system, which includes the following steps:
S1. deploying multiple simulation environments and deploying smart fish after deep reinforcement learning training in the simulation environment, composing simulation test database, simulation testing and parallel sampling of multiple simulation environments, collecting continuous flow field time series information data, and marking the collected continuous flow field time series information data accordingly;
S2. performing data preprocessing on the collected flow field time series information data, the data preprocessing methods include data standardization and segmentation, wherein, data standardization converts the signal into zero mean and unit variance, and segmentation divides the signal into blocks of fixed length, and storing the preprocessed continuous flow field time series information data in the flow field memory database;
S3. using the continuous flow field time series information data in the flow field memory database, adopting supervised learning method, training the lateral line perceptron based on neural network, the lateral line perceptron is set as an advanced neural network built by convolutional neural network or a recurrent neural network based on long short-term memory, in the training of the lateral line perceptron, updating the network weight and bias using back propagation algorithm, using adaptive moment estimation momentum optimizer to adjust relevant parameters, and testing the recognition performance of the trained lateral line perceptron, wherein, there are two test methods for the lateral line perceptron, the first is to reduce the loss value calculated by the cross entropy loss function trained by the training data set to a pre-set standard value, and it is stable in a long time, indicating that the network optimization is completed; the second is to use the trained perceptron to perform pre-perception on the judgment data set, the number of pre-perception failures is less than the set expected number of failures, indicating that the network optimization is completed, when the lateral line perceptron does not meet the requirements, returning to step S1, continuing to collect data and training; when the lateral line perceptron meets the requirements, entering the next step;
S4. the lateral line perceptron that meets the requirements of use is coupled with the artificial intelligence fish simulation system, simulation testing in flow field, the lateral line perceptron continuously judges and identifies the current flow field to obtain identification result, sending the current observed flow field sequence data signal of the artificial intelligence fish as the input signal to the trained lateral line perceptron, and quickly outputting the identification result according to the mark established in step S1, and obtaining the identification result, the artificial intelligence fish simulation system adopts the corresponding swimming strategy according to the identification results;
S5. entering the simulation test in S4 into the simulation test database in step S1.

### Example 1

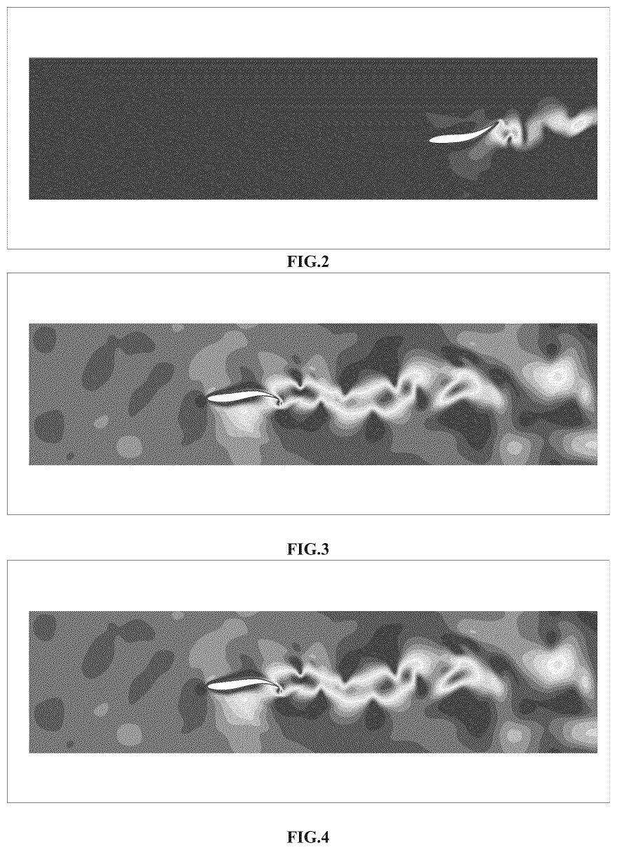

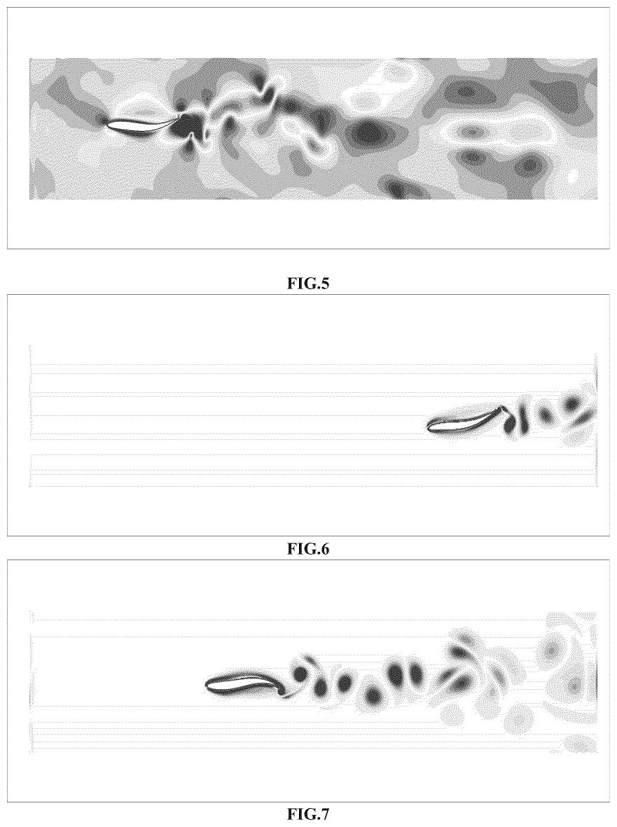

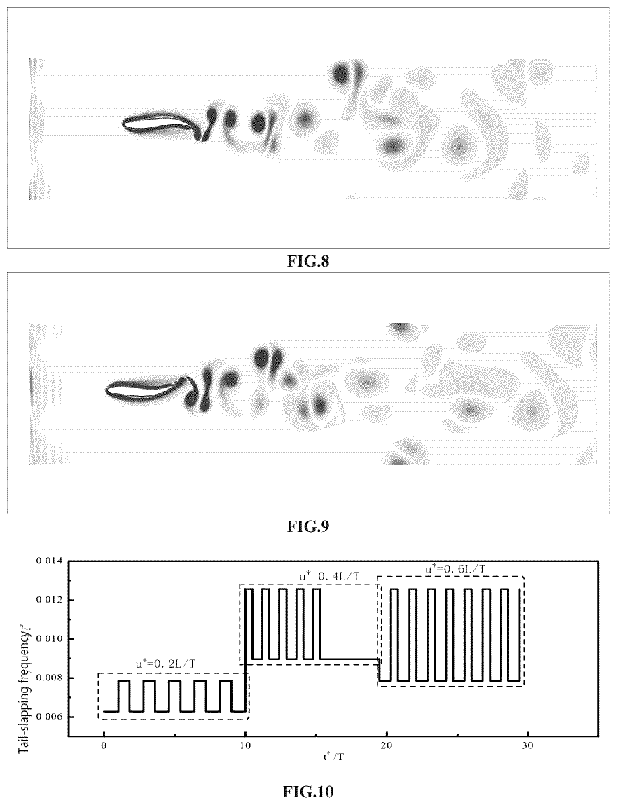

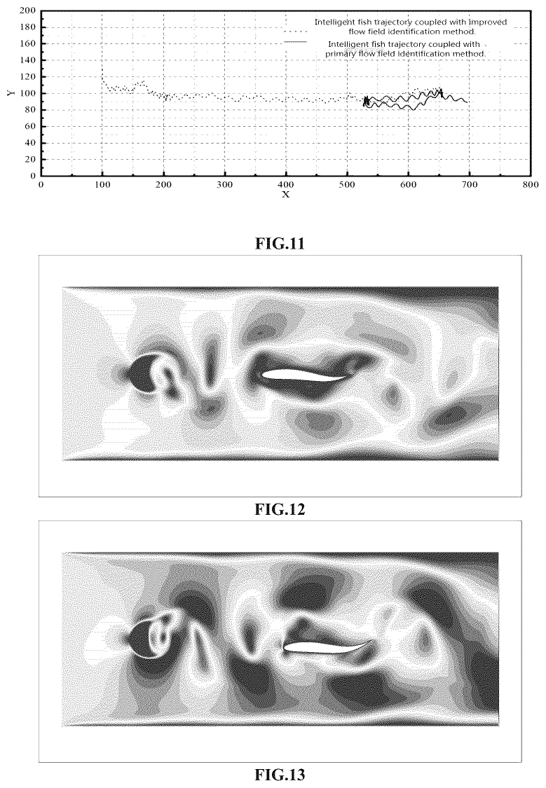

For the case where the fish actively goes up against the water under unsteady flow, given an unsteady flow process, defining a fish body characteristics standard tail-slapping cycle as T, T is set to zero dimension lattice time 1000, defining a fish body characteristic body length as L, L is set to zero dimension lattice length 100, the swimming goal of artificial intelligence fish is: fish can identify the flow field of the current environment under the condition of unsteady flow and complete the process of going up against the water. The boundary conditions are: the upstream is a velocity boundary inlet, and the upstream velocity changes from 0.2 L/T→0.4 L/T→0.6 L/T respectively, wherein, if the flow rate increases to 0.4 L/T, the time is 8.0 T, if the flow rate increases to 0.6 L/T, the time is 18.0 T; the downstream is a free flow outlet, and the upper and lower walls of the flow field are periodic boundaries;
as shown in FIGS. 2-9, when the artificial intelligence fish recognizes the change of the current incoming flow velocity through the lateral line perceptron, they will select the tail-slapping frequency vector [ω₁, ω₂, ω₃; . . . ωₙ] matching the current flow field in the existing brain memory library A to perform three modes of acceleration, deceleration and cruise maneuvers, as shown in FIGS. 10-11, it can be seen from the tail-slapping frequency diagrams and the trajectory comparison diagrams that the artificial intelligence fish adopting the technical scheme of the present invention can quickly identify the change of the surrounding environment, thereby prompting the artificial intelligence fish to adopt a swimming strategy to cope with the current environmental changes. However, for the artificial intelligence fish with coupled primary lateral line function, in the unsteady flow field of continuous transformation, their lateral line function will fail, and the fish cannot quickly identify changes in the surrounding environment and cannot choose the appropriate swimming strategy, so they are washed downstream.

### Example 2

For the case of Karman gait maintenance in unsteady turbulent flow field, given an unsteady flow process, defining a fish body characteristics standard tail-slapping cycle as T, T is set to zero dimension lattice time 1000, defining a fish body characteristic body length as L, L is set to zero dimension lattice length 100, the swimming goal of artificial intelligence fish is: fish can identify the flow field of the current environment under the condition of unsteady flow, and choose the tail-slapping frequency which is most suitable for the current flow field using the position of Karman gait maintenance in the turbulent flow field. The boundary conditions are: the upstream is the velocity boundary inlet, setting a D-pillar with a diameter of 0.4 L at a distance of 1.00 L from the upstream entrance, the upstream flow rate changes from 1.00 L/T→1.25 L/T→1.50 L/T respectively, wherein, if the flow rate increases to 1.25 L/T, the time is 8.0 T, if the flow rate increases to 1.50 L/T, the time is 18.0 T; the downstream is a free flow outlet, and the upper and lower walls of the flow field are periodic boundaries.

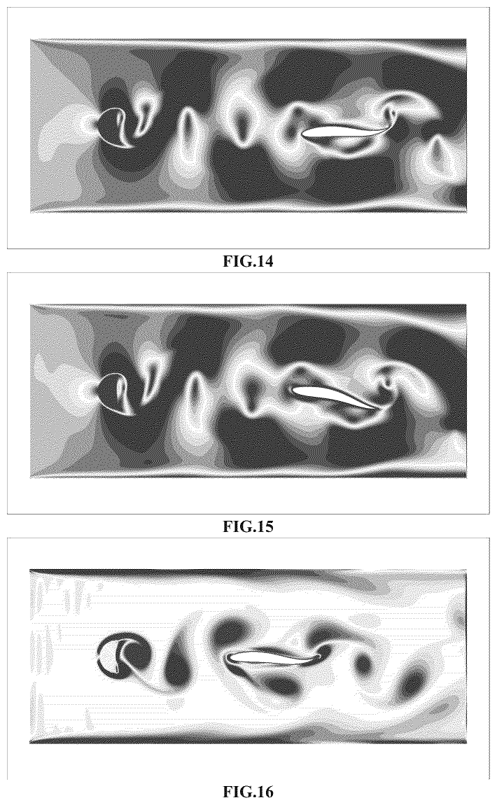

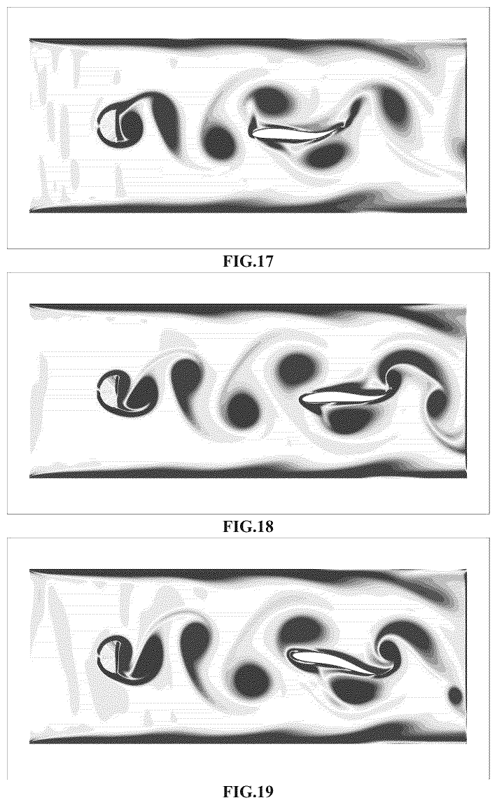

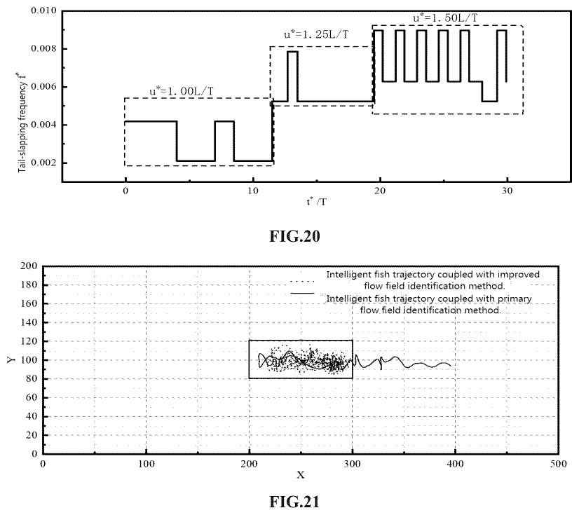

as shown in FIGS. 12-19, when the artificial intelligence fish recognizes the change of the current incoming flow velocity through the lateral line perceptron, they will select the tail-slapping frequency vector [ω₁, ω₂, ω₃; . . . ωₙ;] matching the current flow field in the existing brain memory library A to perform three modes of acceleration, deceleration and cruise maneuvers, as shown in FIGS. 20-21, it can be seen from the tail-slapping frequency diagrams and the trajectory comparison diagrams that the artificial fish coupled with the technical scheme of the present invention can quickly identify the change of the surrounding environment, thereby prompting the artificial intelligence fish to adopt a swimming strategy to cope with the current environmental changes. The artificial fish that perceives the current environmental flow field will mainly adopt the Karman gait close to the vortex shedding frequency of the current flow field in most of the time, in addition, auxiliary to accelerate or decelerate maneuver to maintain their position in the turbulent flow field. But for the fish coupling primary lateral line function, in the unsteady flow field of continuous transformation, their lateral line function will fail, and the fish cannot quickly identify changes in the surrounding environment and cannot make timely adjustment of swimming posture, so they are washed downstream.

Therefore, the present invention provides a flow field identification method of artificial intelligence fish simulation system. It can fully reflect the characteristics of the flow field from the amplitude, frequency, wavelength and other aspects, so that the intelligent fish has the ability to continuously perceive the changes of the flow field in the platform simulation, which is closer to the behavior of real fish in nature, and the simulation effect of fish is better.

Finally, it should be noted that the above implementation examples are only used to explain the technical scheme of the invention rather than to restrict it. Although the invention is described in detail with reference to the better implementation examples, ordinary technicians in this field should understand that they can still modify or replace the technical scheme of the invention, and these modifications or equivalent replacements cannot make the modified technical scheme out of the spirit and scope of the technical scheme of the invention.

What is claimed:

1. A flow field identification method of artificial intelligence fish simulation system, comprising following steps:
S1, deploying multiple simulation environments and deploying smart fish after a deep reinforcement learning training in the simulation environments, composing simulation test database, simulation testing, and parallel sampling of multiple simulation environments, collecting continuous flow field time series information data, and marking the collected continuous flow field time series information data accordingly;
S2, performing data preprocessing on the collected flow field time series information data, and storing the preprocessed continuous flow field time series information data in a flow field memory database;
S3, using the continuous flow field time series information data in the flow field memory database, adopting supervised learning method, training a lateral line perceptron based on neural network, and testing recognition ability of the lateral line perceptron after training, wherein testing the recognition ability of the lateral line perceptron comprises:
a first method to reduce a loss value that is calculated by a cross entropy loss function trained by the training data, wherein a desired loss value is set to a pre-set standard value, and it is stable for a long time, for indicating that a network optimization is completed; and
a second method, wherein the second method is to use the trained perceptron to perform pre-perception on a judgment data set and check whether the number of pre-perception failures is less than the set expected number of failures, for indicating that a network optimization is completed, wherein,
when the lateral line perceptron does not meet the requirements, returning to step S1, continuing to collect data and training; and
when the lateral line perceptron meets the requirements, entering the next step;
S4, the lateral line perceptron that meets the requirements of use is coupled with the artificial intelligence fish simulation system, simulation testing in flow field, the lateral line perceptron continuously judges and identifies a current flow field to obtain identification result, the artificial intelligence fish simulation system adopts a corresponding swimming strategy according to the identification results; and
S5, entering the simulation test in S4 into the simulation test database in step S1.

2. The flow field identification method of the artificial intelligence fish simulation system according to claim 1, wherein in step S2, the data preprocessing methods include data standardization and segmentation, the data standardization converts the signal into zero mean and unit variance, and the segmentation divides the signal into blocks of fixed length.

3. The flow field identification method of the artificial intelligence fish simulation system according to claim 1, wherein in the step S3, the lateral line perceptron is set as an advanced neural network built by convolutional neural network or a recurrent neural network based on long short-term memory.

4. The flow field identification method of the artificial intelligence fish simulation system according to claim 1, wherein in the training method of step S3, in the training of the lateral line perceptron, updating the network weight and bias using back propagation algorithm, using adaptive moment estimation momentum optimizer to adjust relevant parameters.

5. (canceled)

6. The flow field identification method of the artificial intelligence fish simulation system according to claim 1, wherein in the step S4, the identification method is to send the current observed flow field sequence data signal of smart fish as the input signal to the trained lateral line perceptron, and quickly output the identification result according to the mark established in step S1.
